(19) United States
(12) Patent Application Publication
(10) Pub. No.: US 2004/0159166 A1
(43) Pub. Date: Aug. 19, 2004

(54) Solid-state piezoelectric motion transducer

(76) Inventor: Peter J. Schiller, Coon Rapids, MN (US)

Correspondence Address: Min S. (Amy) Xu, DORSEY & WHITNEY LLP, Intellectual Property Department, 50 South Sixth Street, Suite 1500, Minneapolis, MN, 55402-1498, US

(21) Appl. No.: 10/777,440

(22) Filed: Feb. 12, 2004

Related U.S. Application Data
(60) Provisional application No. 60/447,189, filed on Feb. 13, 2003.
(60) Provisional application No. 60/468,785, filed on May 8, 2003.

(51) Int. Cl. G01L 1/00

(52) U.S. Cl. 73/862.381

(57) ABSTRACT

The present invention provides a solid-state piezoelectric motion transducer device formed by thin films. The motion transducer is used for generating an electrical signal output proportional to motion quantities such as acceleration, vibration, and rotation. The motion transducer is also used for generating motion in response to applied electrical input signals. The precision thin-film piezoelectric elements are configured and arranged on a semi-rigid structure with a high degree of symmetry, thereby providing improved correlation between the electrical input or output signal quantities and the associated mechanical motion.

### CROSS-REFERENCE TO RELATED APPLICATION(S)

The present utility patent application claims priority of U.S. Provisional Patent Application, Serial No. 60/447,189, filed Feb. 13, 2003, and is related to U.S. utility patent application, Ser. No. 10/055,186, filed Jan. 23, 2002 and U.S. provisional patent application, Serial No. 60/468,785, filed May 8, 2003; subject matter of which are incorporated herewith by reference.

### FIELD OF THE INVENTION

The present invention relates generally to a piezoelectric motion transducer device, and more particularly, to a solid-state thin film piezoelectric device for measuring or imparting mechanical motion.

### BACKGROUND OF THE INVENTION

Piezoelectric materials are used in a variety of sensors and actuators. Piezoelectric materials convert mechanical energy to electrical energy and vice versa. For instance, if pressure is applied to a piezoelectric crystal, an electrical signal is generated in proportion thereby producing the function of a sensor. Generation of an electrical signal in response to an applied force or pressure is known as the “primary piezoelectric effect”. Similarly, if an electrical signal is applied to a piezoelectric crystal, it will expand in proportion as an actuator. Geometric deformation (expansion or contraction) in response to an applied electric signal is known as the “secondary piezoelectric effect”. Whether operated as a sensor or actuator, electrically-conductive electrodes must be appropriately placed on the piezoelectric crystal for collection or application of the electrical signal, respectively. Therefore, a piezoelectric sensor (actuator) consists nominally of a) a portion of piezoelectric material, and b) electrically-conductive electrodes suitably arranged to transfer electrical energy to (from) an external power source.

Piezoelectric materials have been utilized in the prior art to create a variety of simple sensors and actuators. Examples of sensors include vibration sensors, microphones, and ultrasonic sensors. Examples of actuators include ultrasonic transmitters and linear positioning devices. However, in most of these prior art examples, bulk piezoelectric material is machined and assembled in a coarse manner to achieve low-complexity devices. In a few examples of the prior art, bulk piezoelectric material is machined into complex mechanical structures to perform somewhat higher functionality. However, manufacturing complex devices from bulk piezoelectric material is prohibitively expensive for many applications.

Therefore, there is a need for an improved piezoelectric transducer device.

### SUMMARY OF THE INVENTION

To solve the above and the other problems, the present invention provides a solid-state piezoelectric device formed by thin films. Similar to silicon Integrated Circuits (ICs), a solid-state piezoelectric device is built up by a series of thin films, typically less than or about 5 micron (0.005 mm) in thickness. A solid-state piezoelectric device can be configured to operate as a sensor that generates an electrical output signal proportional to mechanical motion. One such solid-state piezoelectric sensor is an accelerometer that generates an electrical output signal in proportion to acceleration. Another such solid-state piezoelectric sensor is a rate sensor that generates an electric output signal in proportion to the rate of rotation. A solid-state piezoelectric device can be configured to operate as an actuator that generates mechanical motion in proportion to an applied electrical signal. By combining both sensor and actuator operations into a single device, a variety of useful devices can be manufactured.

The present invention provides multiple precision thin-film piezoelectric elements on a semi-rigid structure to detect mechanical motion while rejecting spurious noise created by package strain, thermal gradients, and electromagnetic interference. The thin-film piezoelectric element arrangements of the present invention generate electrical output signals that are highly selective to specific motion directions. Moreover, the accelerometer embodiments of the present invention are capable of simultaneously generating three separate electrical output signals corresponding to motion in each of three orthogonal directions. Further rate sensor embodiments of the present invention are capable of generating separate electrical output signals corresponding to rotation about multiple orthogonal axial directions. The ability to accurately discriminate the direction of motion is an important and differentiating feature of the present invention.

The present invention utilizes piezoelectric materials in a thin-film format. The thin-film distinction enables transducers with a far higher degree of complexity and accuracy. Thin-films offer the following key advantages:

Matching—Thin-film piezoelectric materials are deposited and defined on an atomic scale utilizing fabrication processes common in the semiconductor industry. The result is that thin-film piezoelectric elements can be consistently manufactured with element matching more than 100× better than conventional bulk machined devices.

Density—Thin-film piezoelectric elements are defined using microlithography, a process which enables extremely small dimensions (less than 0.001 mm, or 1 micron) to be delineated in a consistent and controlled manner. The result is that a large number of precision piezoelectric elements can be defined on a single microscopic transducer device.

Accuracy—In a thin-film format, piezoelectric materials exhibit reduced levels of random noise. At system level, the effect of lower noise is higher accuracy readings.

Low-Cost—Thin-film piezoelectric elements are defined using batch processing techniques common in the semiconductor industry. A typical deposition, pattern transfer, and etch sequence on a single silicon wafer defines literally millions of precision piezoelectric elements on thousands of transducers.

Size—Thin-film piezoelectrics enable far smaller devices to be manufactured.

Low Power—Less energy is required to operate a thin-film device.

The above advantages are inherent to the present invention and enable novel configurations and unique features that increase the overall device and system performance.

These and other features and advantages of the present invention will become apparent to those skilled in the art from the following detailed description, wherein it is shown and described illustrative embodiments of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a cross-sectional view of one embodiment of a solid-state thin-film piezoelectric motion transducer device, in accordance with the principles of the present invention.

FIG. 2 is a cross-sectional view of one embodiment of a solid-state thin-film piezoelectric motion transducer device with metal interconnect means for connecting to an external electrical circuit, in accordance with the principles of the present invention.

FIG. 3 is a top view of a solid-state thin-film piezoelectric motion transducer device on a semiconductor chip, in accordance with the principles of the present invention.

FIG. 4 is a top view of piezoelectric element placement on a circular solid-state thin-film piezoelectric motion transducer device, in accordance with the principles of the present invention.

FIG. 5 is a top view of one embodiment of a 16-piezoelectric element configuration on a solid-state piezoelectric motion transducer device, in accordance with the principles of the present invention.

FIG. 6 is a cross-sectional view of one embodiment of a solid-state piezoelectric motion transducer device when subjected to acceleration in a vertical direction, illustrating the correlation between piezoelectric element placement and symmetric bending moments in the device, in accordance with the principles of the present invention.

FIG. 7 is a cross-sectional view of one embodiment of a solid-state piezoelectric motion transducer device when subjected to acceleration in a lateral direction, illustrating the correlation between piezoelectric element placement and anti-symmetric bending moments in the device, in accordance with the principles of the present invention.

FIG. 8 is a circuit diagram showing how the piezoelectric elements in the 16-element configuration of FIG. 5 are connected electrically to simultaneously generate three separate differential electrical output signals that are proportional to acceleration in each of three orthogonal directions, in accordance with the principles of the present invention.

FIG. 9 is a circuit diagram showing how the piezoelectric elements in the 16-element configuration of FIG. 5 are connected electrically to create a single-axis rate sensor, in accordance with the principles of the present invention, wherein twelve (12) of the piezoelectric elements are connected to generate two separate differential electrical output signals; the first differential output signal is in proportion to vibration amplitude (and acceleration) along a first lateral direction; the second differential output signal is in proportion to vibration amplitude (and acceleration) along a second lateral direction, the second lateral direction being perpendicular to the first lateral direction; the remaining 4 piezoelectric elements in the FIG. 5 configuration are electrically connected to form an actuator that imparts vibration selectively along the first lateral direction; the circuit diagram further details how the differential signals are amplified with low-noise amplifiers to create two secondary output signals; the first secondary output signal is processed with control electronics and returned to the 4-element actuator to create stable vibration selectively along the first lateral direction; the second secondary output signal is proportional to the rate of rotational motion about an axis perpendicular to both the first lateral direction and the second lateral direction, according to the Coriolis effect.

FIG. 10 is a circuit diagram showing how the piezoelectric elements in the 16-element configuration of FIG. 5 are connected electrically to create another embodiment of a single-axis rate sensor, in accordance with the principles of the present invention; wherein eight (8) of the piezoelectric elements are connected to generate two separate differential electrical output signals; the first differential output signal is in proportion to vibration amplitude (and acceleration) along a vertical direction; the second differential output signal is in proportion to vibration amplitude (and acceleration) along a first lateral direction, the first lateral direction being perpendicular to the vertical direction; the remaining 8 piezoelectric elements in the FIG. 5 configuration are electrically connected to form an actuator that imparts vibration selectively along the vertical direction; the differential signals are amplified with low-noise amplifiers to create two secondary output signals; the first secondary output signal is processed with control electronics and returned to the 8-element actuator to create stable vibration selectively in the vertical direction; the second secondary output signal is proportional to the rate of rotational motion about a second lateral axis direction perpendicular to both the first lateral direction and the vertical direction.

FIG. 11 is a top view of one embodiment of a 2-piezoelectric element configuration on a solid-state thin-film piezoelectric motion transducer device, in accordance with the principles of the present invention.

FIG. 12 is a circuit diagram showing how the piezoelectric elements in the 2-element configuration of FIG. 11 are connected electrically to generate a differential electrical output signal that is proportional to acceleration in a vertical direction, in accordance with the principles of the present invention, wherein the differential signal is amplified with a low-noise amplifier to create a secondary output signal.

FIG. 13 is a top view of one embodiment of a 8-piezoelectric element configuration on a solid-state thin-film piezoelectric motion transducer device, in accordance with the principles of the present invention.

FIG. 14 is a circuit diagram showing how the piezoelectric elements in the 8-element configuration of FIG. 13 are connected electrically to generated two differential electrical output signal that are proportional to acceleration in two orthogonal lateral directions, in accordance with the principles of the present invention, wherein the differential signals are amplified with low-noise amplifiers to create two secondary output signals.

FIG. 15 is a top view of one embodiment of a 24-piezoelectric element configuration on a solid-state piezoelectric motion transducer device, in accordance with the principles of the present invention.

FIG. 16 is a circuit diagram showing how the piezoelectric elements in the 24-element configuration of FIG. 15 are connected electrically to create a dual-axis rotational rate sensor, in accordance with the principles of the present invention, wherein sixteen (16) of the piezoelectric elements are connected to generate three separate differential electrical output signals, the first differential output signal is in proportion to vibration amplitude (and acceleration) along a first lateral direction, the second differential output signal is in proportion to vibration amplitude (and acceleration) along a second lateral direction, the second lateral direction being perpendicular to the first lateral direction, the third differential output signal is in proportion to vibration amplitude (and acceleration) along a vertical direction, the vertical direction being perpendicular to both the first lateral direction and the second lateral direction, the remaining 8 piezoelectric elements in the FIG. 15 configuration are electrically connected to form an actuator that imparts vibration selectively along the vertical direction, the differential signals are amplified with low-noise amplifiers to create three secondary output signals, the third secondary output signal (derived from the third differential output signal) is processed with control electronics and returned to the 8-element actuator to create stable vibration selectively along the vertical direction, the first secondary output signal (derived from the first differential output signal) is proportional to the rate of rotational motion about an axis parallel to the second lateral direction, according to the Coriolis effect; the second secondary output signal (derived from the second differential output signal) is proportional to the rate of rotational motion about an axis parallel to the first lateral direction, according to the Coriolis effect.

FIG. 17 is a circuit diagram showing how the piezoelectric elements in the 24-element configuration of FIG. 15 are connected electrically to create another embodiment of a dual-axis rotational rate sensor, wherein twenty (20) of the piezoelectric elements are connected to generate three separate differential electrical output signals, the first differential output signal is in proportion to vibration amplitude (and acceleration) along a vertical direction, the second differential output signal is in proportion to vibration amplitude (and acceleration) along a first lateral direction, the second lateral direction being perpendicular to the vertical direction, the third differential output signal is in proportion to vibration amplitude (and acceleration) along a second lateral direction, the second lateral direction being perpendicular to both the first lateral direction and the vertical direction, the remaining 4 piezoelectric elements in the FIG. 15 configuration are electrically connected to form an actuator that imparts vibration selectively along the second lateral direction, the differential signals are amplified with low-noise amplifiers to create three secondary output signals, the third secondary output signal (derived from the third differential output signal) is processed with control electronics and returned to the 4-element actuator to create stable vibration selectively along the second lateral direction, the first secondary output signal (derived from the first differential output signal) is proportional to the rate of rotational motion about an axis parallel to the vertical direction, according to the Coriolis effect, the second secondary output signal (derived from the second differential output signal) is proportional to the rate of rotational motion about an axis parallel to the vertical direction, according to the Coriolis effect.

FIG. 18 is a circuit diagram showing how the piezoelectric elements in the 24-element configuration of FIG. 15 are connected electrically to simultaneously generate three separate differential electrical output signals that are proportional to acceleration in each of three orthogonal directions, in accordance with the principles of the present invention, wherein the differential signals are amplified with low-noise amplifiers to create three secondary output signals.

FIG. 19 is a top view of one embodiment of a 32-piezoelectric element configuration on a solid-state thin-film piezoelectric motion transducer device, in accordance with the principles of the present invention.

### DETAILED DESCRIPTION OF THE PREFERRED EMBODIMENTS

The present invention provides a solid-state piezoelectric motion transducer device formed by thin films. Depending on the configuration and associated electronics, the present invention can be operated as a sensor, whereby it generates an electrical output signal in response to applied mechanical motion. With an alternative configuration or associated electronics, the present invention can be operated as an actuator, whereby it generates mechanical motion when an electrical input signal is applied. In some embodiments, the present invention simultaneously includes both sensor and actuator functions to produce higher order operation. During sensor operation, the precision thin-film piezoelectric elements are configured and arranged on a semi-rigid structure to selectively provide electrical output signals that are highly specific to motion along a particular physical direction. During actuator operation, the precision thin-film piezoelectric elements are configured and arranged on a semi-rigid structure to selectively provide mechanical motion this is highly specific to a particular physical direction. The present invention further provides means for simultaneously sensing or actuating motion along multiple physical directions. The present invention further provides means for differential sensing and actuation. That is, when operated as a sensor, the present invention provides a first electrical output signal of first polarity and a second electrical output signal of second polarity wherein the difference between the first electrical output signal and the second electrical output signal is proportional to motion in a specific physical direction. Furthermore, the differential output signal has reduced response to motion in other directions, and reduced response to extraneous interference caused by package strain, thermal gradients, and electromagnetic interference. When operated as an actuator, the present invention provides a first actuator element and a second actuator element to which is applied a first electrical input signal and a second electrical input signal. The differential actuator pair provides means for selectively imparting motion along a specific physical direction while suppressing motion along other directions.

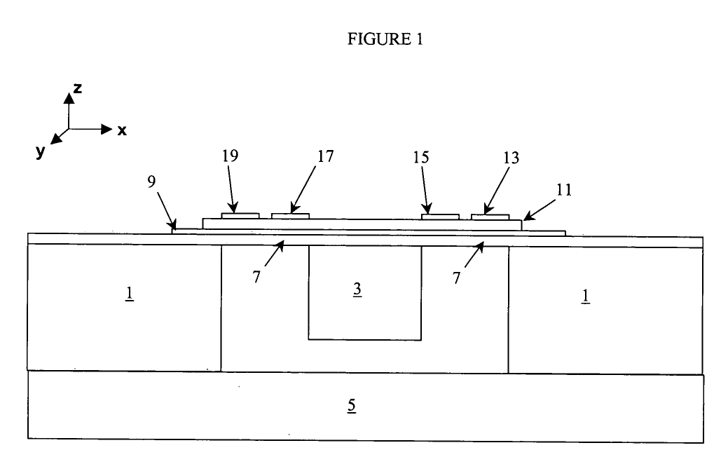

One embodiment of a solid-state thin-film piezoelectric motion transducer device (also referred to as just “motion transducer”) is shown in FIG. 1. FIG. 1 is a representative cross section of the motion transducer device. The device includes a base support 5, a support substrate 1, and a mass 3 disposed in a cavity of the support substrate 1. The mass 3 is preferably a cylindrical silicon seismic mass or the like that is suspended on a toroidal thin-film membrane 7 on which are a series of thin-film piezoelectric elements. The piezoelectric elements are comprised of a lower metal electrode 9, a layer of piezoelectric material 11, and a series of upper metal electrodes 13, 15, 17, and 19. Each piezoelectric element is defined in the XY plane by the area of the upper metal electrode. In FIG. 1, there are four piezoelectric elements shown, corresponding to a first upper metal electrode 13, a second upper metal electrode 15, a third upper metal electrode 17, and a fourth upper metal electrode 19. The four piezoelectric elements in FIG. 1 share a common piezoelectric layer 11 and a lower metal electrode 9. Typically, the height of the seismic mass 3 is about 500 microns, the diameter of the seismic mass 3 is about 400 microns, while the outer diameter of the membrane toroid 7 is about 700 microns. The membrane toroid can be realized with a variety of different materials that exhibit flexibility, resistance to fatigue, and good thermal expansion match to the surrounding silicon substrate. Preferred materials for the membrane are single-crystal silicon, polycrystalline silicon, and silicon nitride with a typical thickness of about 1 micron. However, some accelerometers designed for high frequency or high range applications would utilize a much thicker membrane. Similarly, depending on the particular application and production requirements, the dimensions of seismic-mass 3 and membrane toroid 7 will vary considerably. The piezoelectric elements are formed from a single layer of metal (preferably platinum about 0.1 microns thick) that forms the common lower electrode 9 and a single layer of piezoelectric thin film 11 (preferably PZT about 1 micron thick). By utilizing a single common layer for the lower electrode 9 and piezoelectric film 11, matching between elements and element density is increased; these factors improve the motion transducer's specificity and accuracy, particularly with regard to physical direction. The piezoelectric elements are defined by upper metal electrodes 13, 15, 17, and 19 (preferably platinum about 0.1 microns thick). Since the piezoelectric film 11 is non-conductive, each piezoelectric element is defined by the upper electrode alone, and electrical interaction between piezoelectric elements is negligible.

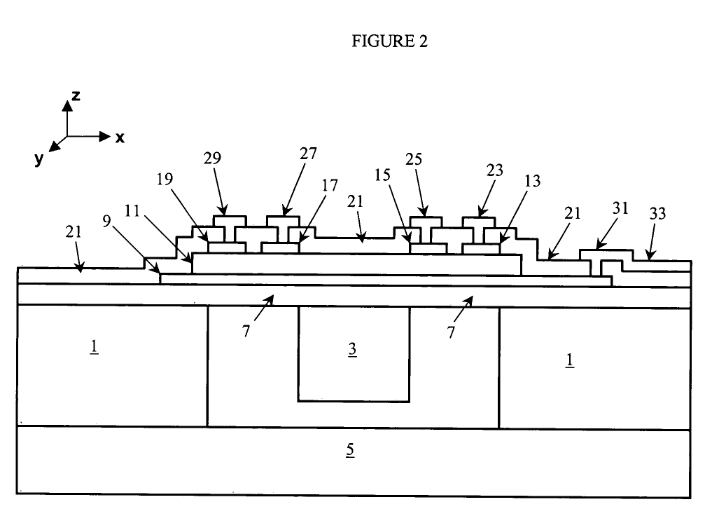

Additional features of one embodiment of a solid-state piezoelectric motion transducer are shown in FIG. 2. The FIG. 2 cross sectional view shows the same components as FIG. 1 but additionally includes a dielectric layer 21 and metal interconnects. In a solid-state device, it is desirable to utilize conductive thin-film layers to create the electrical connections between piezoelectric element electrodes and external electronic circuitry. In a solid-state device according to the present invention, metal interconnects create electrical contacts to the piezoelectric element electrodes. In FIG. 2, the dielectric layer 21 is typically silicon dioxide with a typical thickness of about 0.25 microns. The metal interconnect layer is typically gold with a typical thickness of about 0.5 microns. The metal interconnect layer makes electrical contacts to the piezoelectric electrodes through holes in the dielectric layer 21. For instance in FIG. 2, a first electrical contact 23 is made to first upper metal electrode 13, a second electrical contact 25 is made to second upper metal electrode 15, a third electrical contact 27 is made to third upper metal electrode 17, a fourth electrical contact 29 is made to fourth upper metal electrode 19, and a fifth electrical contact 31 is made to the common lower electrode 9. In FIG. 2, the metal interconnect layer is also used to define electrical connections between piezoelectric elements, or between piezoelectric elements and external electronic circuitry. In FIG. 2, a first interconnect 33 forms an electrical connection between the common lower electrode 9 and external electrical components.

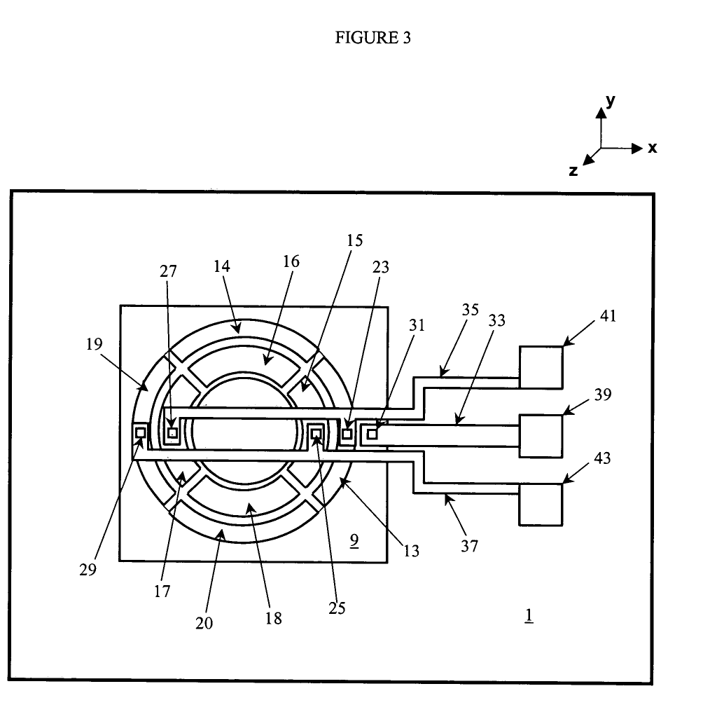

Additional features of an embodiment of a solid-state piezoelectric motion transducer are shown in FIG. 3, wherein the motion transducer is deposed on a silicon substrate 1. A representative motion transducer is shown from a top view perspective, comprised of various metal interconnect along with eight piezoelectric elements, 13, 14, 15, 16, 17, 18, 19, and 20. The motion transducer is typically fabricated on a silicon wafer that is subsequently sawn into chips such as that shown in FIG. 3. The silicon substrate 1, or “chip” is typically several millimeters on a side. In addition to the motion transducer, the silicon chip 1 also includes bond pads which are used to make electrical connections between the motion transducer and external electronic circuitry with metal wires. In FIG. 3, a first bond pad 39 is connected to the common lower electrode 9 of the motion transducer by a first interconnect 33 and a fifth electrical contact 31. Also in FIG. 3, a second bond pad 41 is connected to a first upper metal electrode 13 and a third upper metal electrode 17 by a second interconnect 35, the first electrical contact 23, and the third electrical contact 27. Similarly in FIG. 3, a third bond pad 43 is connected to the second upper metal electrode 15 and the fourth upper metal electrode 19 by a third interconnect 37, a second electrical contact 25, and a fourth electrical contact 29.

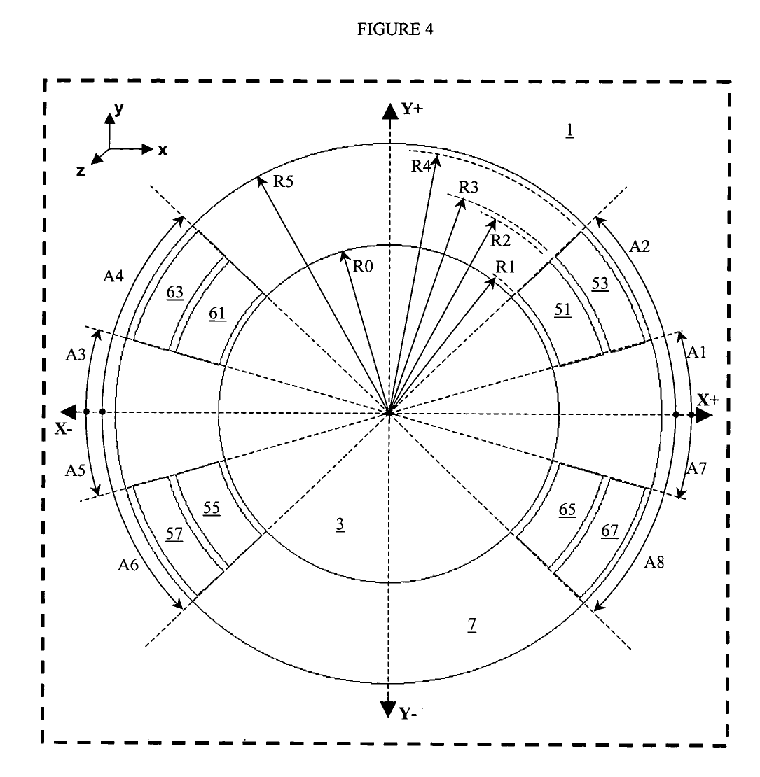

General characteristics of the present invention are shown in FIG. 4 that details the arrangement of piezoelectric elements on the motion transducer. The simplified device in FIG. 4 is shown from the top, detailing only the relative position of the piezoelectric elements in relation to the membrane toroid 3. The device is configured with cylindrical symmetry. That is, the center of the toroid is also the center of the seismic-mass 3 and is the origin for a cylindrical coordinate system. In the cylindrical coordinates of FIG. 4, the angle A=0 corresponds to the positive X-axis. In cylindrical coordinates, each piezoelectric element 51, 53, 55, 57, 61, 63, 65, and 67 is defined by a beginning and ending angle and by a beginning and ending radius. For instance, a first piezoelectric element 51 in FIG. 4 fills the region defined by a first starting angle A1 a first ending angle A2, a first starting radius R1, and a first ending radius R2. In FIG. 4, a second piezoelectric element 53 fills the region defined by a first starting angle A1 a first ending angle A2, a second starting radius R3, and a second ending radius R4. A third piezoelectric element 55 fills the region defined by a second starting angle A5, a second ending angle A6, a first starting radius R1, and a first ending radius R2. A fourth piezoelectric element 57 fills the region defined by a second starting angle A5, a second ending angle A6, a second starting radius R3, and a second ending radius R4. A fifth piezoelectric element 61 fills the region defined by a third starting angle A3, a third ending angle A4, a first starting radius R1, and a first ending radius R2. A sixth piezoelectric element 63 fills the region defined by a third starting angle A3, a third ending angle A4, a second starting radius R3, and a second ending radius R4. A seventh piezoelectric element 65 fills the region defined by a fourth starting angle A7, a fourth ending angle A8, a first starting radius R1, and a first ending radius R2. An eighth piezoelectric element 67 fills the region defined by a fourth starting angle A7, a fourth ending angle A8, a second starting radius R3, and a second ending radius R4. In FIG. 4, the first starting angle A1 and first ending angle A2 are defined counterclockwise with respect to the positive X-axis; the second starting angle AS and second ending angle A6 are defined counterclockwise with respect to the negative X-axis; the third starting angle A3 and third ending angle A4 are defined clockwise with respect to the negative X-axis; the fourth starting angle A7 and fourth ending angle A8 are defined clockwise with respect to the positive X-axis.

The piezoelectric elements in FIG. 4 are arranged with mirror-image symmetry with respect to the coordinate directions. In FIG. 4, the first piezoelectric electrode 51 bounded by first starting angle A1 first ending angle A2, first starting radius R1, and first ending radius R2 is mirror-image symmetric with respect to the X-axis (A=0) to the seventh piezoelectric electrode 65 bounded by fourth starting angle A7, fourth ending angle A8, first starting radius R1, and first ending radius R2 if A7=A1 and A8=A2. Similarly in FIG. 4, the first piezoelectric electrode 51 bounded by first starting angle A1, first ending angle A2, first starting radius R1, and first ending radius R2 is mirror-image symmetric with respect to the Y-axis to the fifth piezoelectric electrode 61 bounded by third starting angle A3, third ending angle A4, first starting radius R1, and first ending radius R2 if A3=A1 and A4=A2. In the same manner with respect to the Y-axis, second and sixth piezoelectric elements 53 and 63 are mirror-image symmetric, third and seventh piezoelectric elements 55 and 65 are mirror-image symmetric, and fourth and eighth piezoelectric elements 57 and 67 are mirror-image symmetric. With respect to the X-axis, second and eighth piezoelectric elements 53 and 67 are mirror-image symmetric, third and fifth piezoelectric elements 55 and 61 are mirror-image symmetric, and fourth and sixth piezoelectric elements 57 and 63 are mirror-image symmetric.

The piezoelectric elements in FIG. 4 are also arranged with 180-degree rotational symmetry with respect to the origin. In FIG. 4, the first piezoelectric electrode 51 bounded by first starting angle A1 and first ending angle A2 is 180-degree rotationally symmetric with the third piezoelectric electrode 55 bounded by second starting angle A5 and second ending angle A6 if A5=A1 and A6=A2. If A5=A1 and A6=A2, then second piezoelectric element 53 is also 180-degree rotationally symmetric with fourth piezoelectric element 57. In FIG. 4, the fifth piezoelectric electrode 61 bounded by third starting angle A3 and third ending angle A4 is 180-degree rotationally symmetric with the seventh piezoelectric electrode 65 bounded by fourth starting angle A7 and fourth ending angle A8 if A7=A3 and A8=A4. If A7=A3 and A8=A4, then sixth piezoelectric element 63 is also 180-degree rotationally symmetric with eighth piezoelectric element 67.

In the present invention, piezoelectric elements are arranged with maximal symmetry with respect to the physical direction of motion with which they are intended to selectively respond. Maximal symmetry is achieved by a) defining each element by a range of rotational angle and range of radius, and b) arranging the elements with mirror-image and/or 180-degree rotational symmetry. By utilizing thin-film piezoelectric elements in a solid-state device, maximal symmetry can be practically realized in accordance with the principles of the present invention without affecting the manufacture cost.

A further embodiment of the present invention that improves the directional discrimination and overall performance of the device is the arrangement of piezoelectric elements into matched differential pairs. For instance in FIG. 4, the first piezoelectric element 51 is coupled with the second piezoelectric element 53 to form a differential pair. For optimal symmetry and electronic impedance matching, it is desirable to make the area of each piezoelectric element in the differential pair equal. This criteria in FIG. 4 is achieved by requiring that (R4•R4−R3•R3)=(R2•R2−R1•R1). When this criteria is met, first and second piezoelectric elements 51 and 53 form a matched differential pair, third and fourth piezoelectric elements 55 and 57 form a matched differential pair, fifth and sixth piezoelectric elements 61 and 63 form a matched differential pair, and seventh and eighth piezoelectric elements 65 and 67 form a matched differential pair.

The common features of the present invention are that a) the piezoelectric elements are arranged into matched differential pairs, b) the overall device is configured in a cylindrical shape, and c) the matched differential pairs are arranged with cylindrical symmetry. These common features provide improvements over the prior art in the ability for this device to a) differentiate specific directions of physical motion, b) reject extraneous environmental effects, and c) simultaneously control or measure motion in multiple directions.

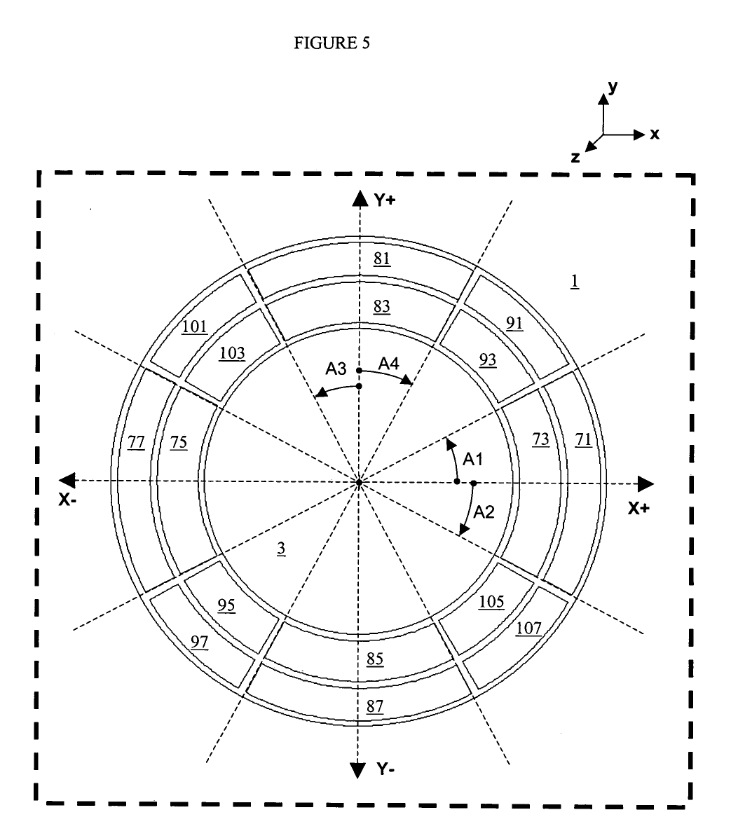

A simplified top view of one embodiment of the present invention is shown in FIG. 5. FIG. 5 illustrates the piezoelectric element configuration for a solid-state motion transducer consistent with the cross sectional views of FIG. 1 and FIG. 2. This device is comprised of sixteen piezoelectric elements arranged as eight matched differential pairs. Matched differential pairs include a first pair comprised of elements 71 and 73, a second pair comprised of elements 75 and 77, a third pair comprised of elements 81 and 83, a fourth pair comprised of elements 85 and 87, a fifth pair comprised of elements 91 and 93, a sixth pair comprised of pairs 95 and 97, a seventh pair comprised of elements 101 and 103, and an eighth pair comprised of elements 105 and 107.

In FIG. 5, the first pair (elements 71 and 73) and second pair (elements 75 and 77) are both mirror-image symmetric with respect to the Y-axis and 180-degree rotationally symmetric. Similarly, the third pair (elements 81 and 83) and fourth pair (elements 85 and 87) are both mirror-image symmetric with respect to the X-axis and 180-degree rotationally symmetric. The fifth, sixth, seventh, and eighth pairs have multiple degrees of symmetry. With respect to mirror-image symmetry with respect to the X-axis, the fifth pair (elements 91 and 93) is symmetric with the eighth pair (elements 105 and 107), and the sixth pair (elements 95 and 97) is symmetric with the seventh pair (elements 101 and 103). With respect to mirror-image symmetry with respect to the Y-axis, the fifth pair (elements 91 and 93) is symmetric with the seventh pair (elements 101 and 103), and the sixth pair (elements 95 and 97) is symmetric with the eighth pair (elements 105 and 107). With respect to 180-degree rotational symmetry, the fifth pair (elements 91 and 93) is symmetric with the sixth pair (elements 95 and 97), and the seventh pair (elements 101 and 103) is symmetric with the eighth pair (elements 105 and 107). To even a further extent, combinations of the fifth, sixth, seventh, and eighth pairs exhibit additional symmetry. With respect to both the X-axis and Y-axis, the combination of the fifth and sixth pairs (elements 91, 93, 95, and 97) is mirror-image symmetric with the combination of the seventh and eighth pairs (elements 101, 103, 105, and 107). With regard to 180-degree rotational symmetry, the combination of the fifth and seventh pairs (elements 91, 93, 101, and 103) is symmetric with the combination of the sixth and eighth pairs (elements 95, 97, 105, and 107), and the combination of the fifth and eighth pairs (elements 91, 93, 105, and 107) is symmetric with the combination of the sixth and seventh pairs (elements 95, 97, 101, and 103). The utility of these symmetries will become evident below with descriptions of the specific motion transducer embodiments.

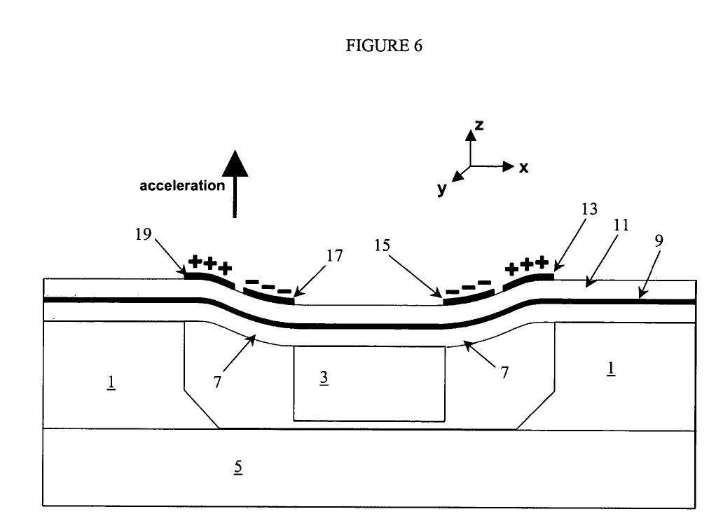

FIG. 6 illustrates a cross section of an embodiment of the present invention when subjected to acceleration in the vertical direction. The FIG. 6 cross section corresponds to FIGS. 1 and 2 which are shown in a non-accelerated condition. During a vertical acceleration, the seismic mass 3 creates a downward force on the membrane toroid 7 causing it to deflect in a symmetric manner along the Z-axis. According to the primary piezoelectric effect, first piezoelectric element 13 and fourth piezoelectric element 19 generate an electrical output signal of first polarity (indicated as “+++” in FIG. 6) in proportion to the acceleration magnitude. At the same time and also according to the primary piezoelectric effect, second piezoelectric element 15 and third piezoelectric element 17 generate an electrical output signal of second polarity (indicated as “−−−” in FIG. 6) in proportion to the acceleration magnitude. The opposing electrical output signal polarities generated by the piezoelectric elements is a result of the bending moment: first and fourth piezoelectric elements 13 and 19 are bent with downward concavity while second and third piezoelectric elements 15 and 17 are bent with upward concavity. The opposing electrical output signal polarity is the reason for arranging the piezoelectric elements into differential pairs as described above. Under normal physical motion (generally below the fundamental resonant frequencies), one element in the differential pair will generate an electrical output signal of first polarity while the other element in the differential pair will generate an electrical output signal of second polarity.

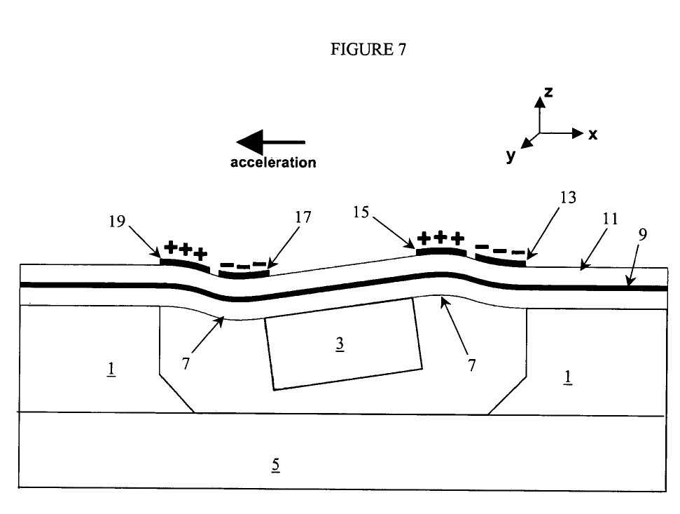

FIG. 7 illustrates a cross section of an embodiment of the present invention when subjected to acceleration in a lateral direction (in the XY plane). The FIG. 7 cross section corresponds to FIGS. 1 and 2 which are shown in a non-accelerated condition. During a lateral acceleration, the seismic mass 3 creates a lateral force on the membrane toroid 7 causing it to deflect in a symmetric manner laterally in the direction of the X-Y plane. According to the primary piezoelectric effect, second piezoelectric element 15 and fourth piezoelectric element 19 generate an electrical output signal of first polarity (indicated as “+++” in FIG. 7) in proportion to the acceleration magnitude. At the same time and also according to the primary piezoelectric effect, first piezoelectric element 13 and third piezoelectric element 17 generate an electrical output signal of second polarity (indicated as “−−−” in FIG. 7) in proportion to the acceleration magnitude. The opposing electrical output signal polarities generated by the piezoelectric elements is a result of the bending moment: second and fourth piezoelectric elements 15 and 19 are bent with downward concavity while first and third piezoelectric elements 13 and 17 are bent with upward concavity. The opposing electrical output signal polarity is the reason for arranging the piezoelectric elements into differential pairs as described above. Under normal physical motion (generally below the fundamental resonant frequencies), one element in the differential pair will generate an electrical output signal of first polarity while the other element in the differential pair will generate an electrical output signal of second polarity.

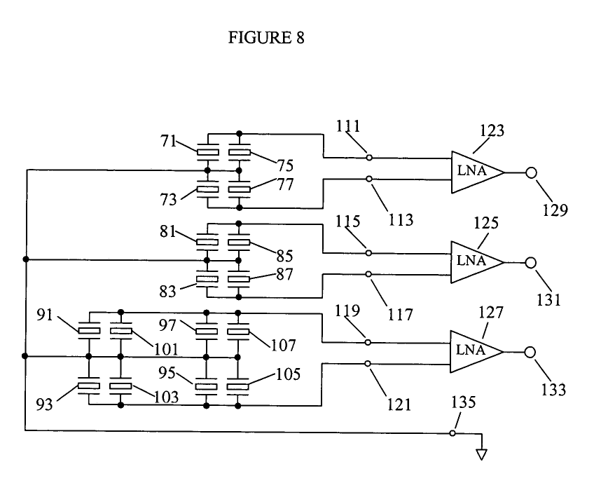

A further embodiment of the present invention is shown in the circuit diagram of FIG. 8 wherein the piezoelectric elements of the FIG. 5 device are electrically connected to form an open-loop triaxial accelerometer. That is, the device in FIG. 8 is a sensor that simultaneously generates three separate electrical output signals corresponding to acceleration in each of the three orthogonal physical directions: the X-axis, the Y-axis, and the Z-axis. In FIG. 8 (reference to the FIG. 5 arrangement), piezoelectric elements 71 and 75 are connected together at circuit node 111 and piezoelectric elements 73 and 77 are connected together at circuit node 113 to create a differential output signal. As described in FIG. 7, during a lateral acceleration along the physical X-direction, elements 71 and 75 will generate an electrical output signal of a first polarity, while elements 73 and 77 will generate an electrical output signal of a second polarity. The resulting combined differential electrical output signal between circuit nodes 111 and 113 is highly selective to acceleration in the physical X-direction by virtue of the symmetry. Similarly, piezoelectric elements 81 and 85 are connected together at circuit node 115 and piezoelectric elements 83 and 87 are connected together at circuit node 117 to create a differential output signal. As described in FIG. 7, during a lateral acceleration along the physical Y-direction, elements 81 and 85 will generate an electrical output signal of a first polarity, while elements 83 and 87 will generate an electrical output signal of a second polarity. The resulting combined differential electrical output signal between circuit nodes 115 and 117 is highly selective to acceleration in the physical Y-direction by virtue of the symmetry. Lastly, piezoelectric elements 91, 97, 101, and 107 are connected together at circuit node 119 and piezoelectric elements 93, 95, 103, and 105 are connected together at circuit node 121 to create a differential output signal. As described in FIG. 6, during a vertical acceleration along the physical Z-direction, elements 91, 97, 101, and 107 will generate an electrical output signal of a first polarity, while elements 93, 95, 103, and 105 will generate an electrical output signal of a second polarity. The resulting combined differential electrical output signal between circuit nodes 119 and 121 is highly selective to acceleration in the physical Z-direction by virtue of the symmetry. Other elements of FIG. 8 include external low-noise amplifiers (LNA) that measure the difference of each combined differential electrical output signal and generate a secondary output in proportion to the acceleration along each orthogonal physical direction. A first LNA 123 amplifies the differential signal between circuit nodes 111 and 113 to generate an electrical output signal at circuit node 129 in proportion to acceleration in the physical X-direction. A second LNA 125 amplifies the differential signal between circuit nodes 115 and 117 to generate an electrical output signal at circuit node 131 in proportion to acceleration in the physical Z-direction. Lastly, a third LNA 127 amplifies the differential signal between circuit nodes 119 and 121 to generate an electrical output signal at circuit node 133 in proportion to acceleration in the physical Z-direction.

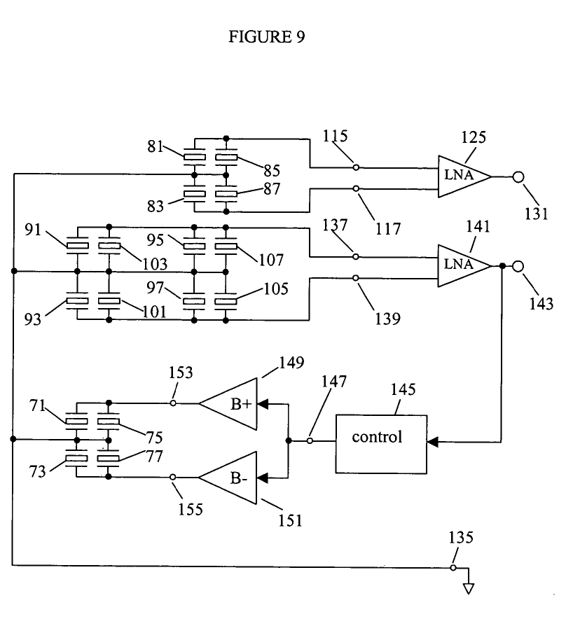

Another embodiment of the present invention is shown in the circuit diagram of FIG. 9 wherein the piezoelectric elements of the FIG. 5 device are electrically connected to form a closed-loop single-axis rotational rate sensor. That is, the device in FIG. 9 is a sensor that generates an electrical output signal proportional to the rate of rotation around an axis parallel to the physical Z-direction. In FIG. 9 (reference to the FIG. 5 arrangement), piezoelectric elements 71 and 75 are connected together at circuit node 153 while piezoelectric elements 73 and 77 are connected together at circuit node 155 to create a differential actuator that selectively generates motion in the physical X-direction when an electrical signal is applied between circuit nodes 153 and 155. The piezoelectric elements 91, 95, 103, and 107 are connected together at circuit node 137 while piezoelectric elements 93, 97, 101, and 105 are connected together at circuit node 139 to create a differential output signal proportional to motion in the physical X-direction. As described in FIG. 7, during a lateral acceleration along the physical X-direction, elements 91, 95, 103, and 107 will generate an electrical output signal of a first polarity, while elements 93, 97, 101, and 105 will generate an electrical output signal of a second polarity. The resulting combined differential electrical output signal between circuit nodes 137 and 139 is highly selective to acceleration in the physical X-direction by virtue of the symmetry. Similarly, piezoelectric elements 81 and 85 are connected together at circuit node 115 while piezoelectric elements 83 and 87 are connected together at circuit node 117 to create a differential output signal. As described in FIG. 7, during a lateral acceleration along the physical Y-direction, elements 81 and 85 will generate an electrical output signal of a first polarity, while elements 83 and 87 will generate an electrical output signal of a second polarity. The resulting combined differential electrical output signal between circuit nodes 115 and 117 is highly selective to acceleration in the physical Y-direction by virtue of the symmetry. Other elements of FIG. 9 include external low-noise amplifiers (LNA) that measure the difference of each combined differential electrical output signal and generate a secondary output in proportion to the acceleration along each orthogonal physical direction. A first LNA 125 amplifies the differential signal between circuit nodes 115 and 117 to generate an electrical output signal at circuit node 131 in proportion to acceleration in the physical Y-direction. A second LNA 141 amplifies the differential signal between circuit nodes 137 and 139 to generate an electrical output signal at circuit node 143 in proportion to acceleration in the physical X-direction. In FIG. 9 control electronics 145 process the output signal at circuit node 143 which is proportional to X-axis motion and generate a feedback signal at circuit node 147. Actuator drivers 149 and 151 convert the feedback signal at circuit node 147 to input electrical signals on circuit nodes 153 and 155 to drive the actuator. The external electronics in conjunction with the motion transducer form a feedback loop that create a stable mechanical vibration along the X-axis consistent with the motion depicted in FIG. 7. According to the Coriolis effect, if the device is subjected to rotation about an axis parallel to the physical Z-direction, a proportional acceleration will occur in the Y-axis direction and be detected by piezoelectric elements 81, 83, 85, and 87. The electrical output signal at circuit node 131 is thereby proportional to the rate of rotation about the Z-axis.

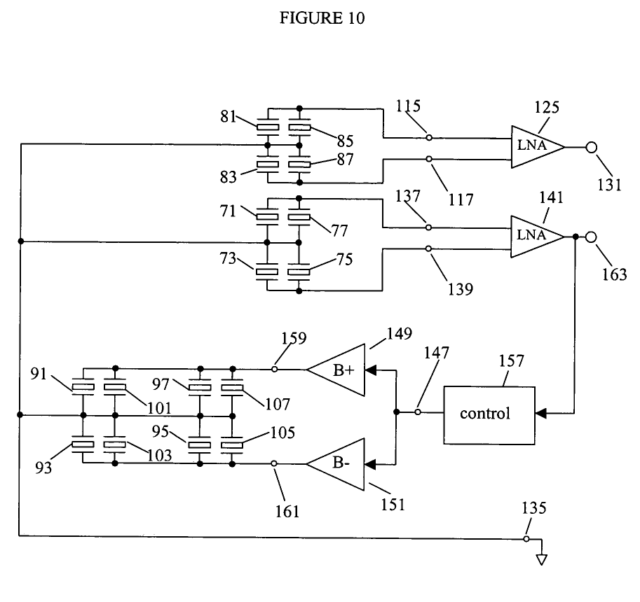

Still another embodiment of the present invention is shown in the circuit diagram of FIG. 10 wherein the piezoelectric elements of the FIG. 5 device are electrically connected to form another type of closed-loop single-axis rotational rate sensor. That is, the device in FIG. 10 is a sensor that generates an electrical output signal proportional to the rate of rotation around an axis parallel to the physical X-direction. In FIG. 10 (reference to the FIG. 5 arrangement), piezoelectric elements 91, 101, 97, and 107 are connected together at circuit node 159 while piezoelectric elements 93, 103, 95, and 105 are connected together at circuit node 161 to create a differential actuator that selectively generates motion in the physical Z-direction when an electrical signal is applied between circuit nodes 159 and 161. The piezoelectric elements 71 and 77 are connected together at circuit node 137 while piezoelectric elements 73 and 75 are connected together at circuit node 139 to create a differential output signal proportional to motion in the Z-direction. As described in FIG. 6, during a vertical acceleration along the physical Z-direction, elements 71 and 77 will generate an electrical output signal of a first polarity, while elements 73 and 75 will generate an electrical output signal of a second polarity. The resulting combined differential electrical output signal between circuit nodes 137 and 139 is highly selective to acceleration in the physical Z-direction by virtue of the symmetry. Similarly, piezoelectric elements 81 and 85 are connected together at circuit node 115 while piezoelectric elements 83 and 87 are connected together at circuit node 117 to create a differential output signal. As described in FIG. 7, during a lateral acceleration along the physical Y-direction, elements 81 and 85 will generate an electrical output signal of a first polarity, while elements 83 and 87 will generate an electrical output signal of a second polarity. The resulting combined differential electrical output signal between circuit nodes 115 and 117 is highly selective to acceleration in the physical Y-direction by virtue of the symmetry. Other elements of FIG. 10 include external low-noise amplifiers (LNA) that measure the difference of each combined differential electrical output signal and generate a secondary output in proportion to the acceleration along each orthogonal physical direction. A first LNA 125 amplifies the differential signal between circuit nodes 115 and 117 to generate an electrical output signal at circuit node 131 in proportion to acceleration in the physical Y-direction. A second LNA 141 amplifies the differential signal between circuit nodes 137 and 139 to generate an electrical output signal at circuit node 163 in proportion to acceleration in the physical Z-direction. In FIG. 10, control electronics 157 process the output signal at circuit node 163 which is proportional to Z-axis motion and generate a feedback signal at circuit node 147. Actuator drivers 149 and 151 convert the feedback signal at circuit node 147 to input electrical signals on circuit nodes 159 and 161 to drive the actuator. The external electronics in conjunction with the motion transducer form a feedback loop that create a stable mechanical vibration along the Z-axis consistent with the motion depicted in FIG. 6. According to the Coriolis effect, if the device is subjected to rotation about an axis parallel to the physical X-direction, a proportional acceleration will occur in the Y-axis direction and be detected by piezoelectric elements 81, 83, 85, and 87. The electrical output signal at circuit node 131 is thereby proportional to the rate of rotation about the X-axis.

The embodiments described in FIGS. 8, 9, and 10 illustrate the present invention whereby a variety of motion transducers can be configured by modifying the electrical connections between piezoelectric elements in FIG. 5 and external electronics. There are a wide variety of electrical connections and external electronics that may be reconfigured to achieve a particular function. The embodiments presented here are illustrative in nature and not intended to limit the scope or spirit of the present invention.

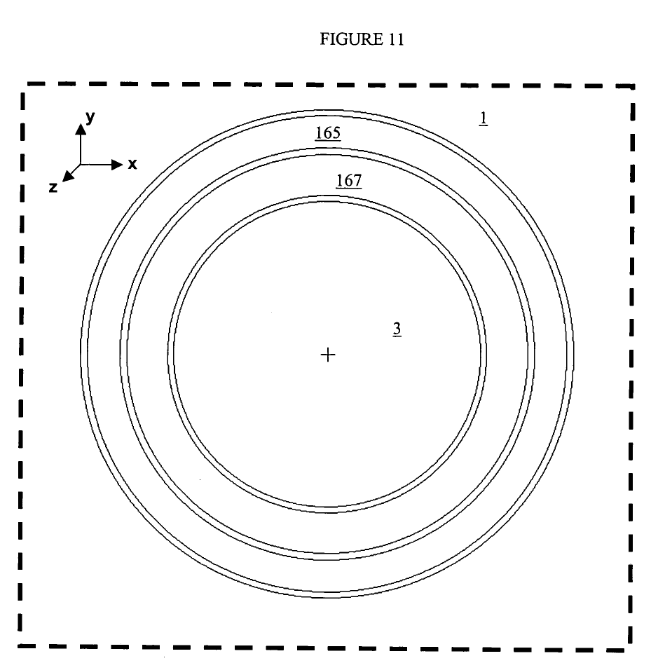

A simplified top view of another embodiment of the present invention is shown in FIG. 11. FIG. 11 illustrates the piezoelectric element configuration for a motion transducer consistent with the cross sectional views of FIG. 1 and FIG. 2. This device is comprised of an outer piezoelectric element 165 and an inner piezoelectric element 167 arranged as a single differential element pair. The differential element pair in FIG. 11 is rotationally symmetric and will be responsive to physical motion in the Z-direction. Because of the mirror-image symmetry in both the X-direction and Y-direction, the FIG. 11 device will reject motion along these lateral directions.

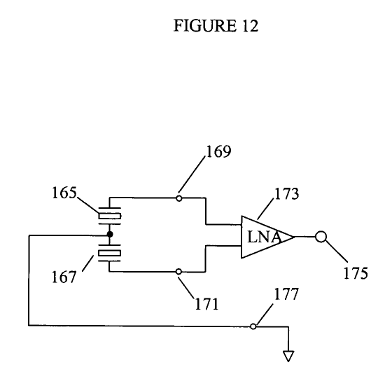

A further embodiment of the present invention is shown in the circuit diagram of FIG. 12 wherein the outer piezoelectric element 165 and inner piezoelectric element 167 of the FIG. 11 device are electrically connected to form an open-loop single-axis accelerometer. That is, the device in FIG. 12 is a sensor that generates an electrical output signal corresponding to acceleration in physical Z-axis direction. In FIG. 12 (reference to the FIG. 11 arrangement), piezoelectric elements 165 and 167 form a differential piezoelectric element pair according to the present invention and create a differential electrical output signal at circuit nodes 169 and 171. As described in FIG. 6, during a vertical acceleration along the physical Z-direction, element 165 will generate an electrical output signal of a first polarity, while element 167 will generate an electrical output signal of a second polarity. The resulting differential electrical output signal appearing between circuit nodes 169 and 171 is highly selective to acceleration in the physical Z-direction by virtue of the symmetry. Other elements of FIG. 12 include an external low-noise amplifier (LNA) 173 that measures the differential electrical output signal between circuit nodes 169 and 171 and generates a secondary output at circuit node 175 in proportion to the acceleration along the physical Z-direction.

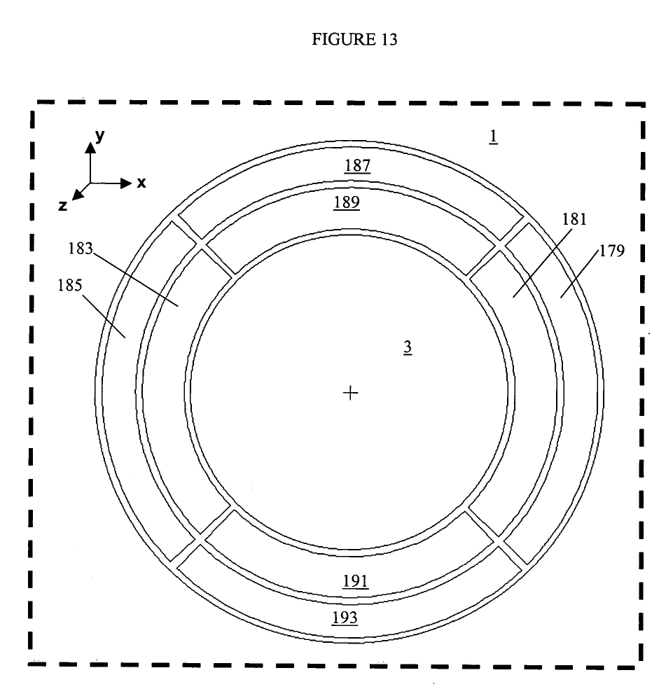

A simplified top view of another embodiment of the present invention is shown in FIG. 13. FIG. 13 illustrates the piezoelectric element configuration for a motion transducer consistent with the cross sectional views of FIG. 1 and FIG. 2. This device is comprised of eight piezoelectric elements arranged as four differential element pairs. Differential pairs include 179 and 181, 183 and 185, 187 and 189, and 191 and 193. The first differential pair comprised of elements 179 and 181 is mirror-image symmetric about the Y-axis with the second differential pair comprised of elements 183 and 185 and when properly connected electrically, will be responsive to physical motion in the X-direction. Similarly, the third differential pair comprised of elements 187 and 189 is mirror-image symmetric about the X-axis with the fourth differential pair comprised of elements 191 and 193 and when properly connected electrically, will be responsive to physical motion in the Y-direction. As will become apparent below, the electrical connection of the elements determines the physical axis to which an element pair will respond. For instance, while a first circuit connection between first and second differential pairs (elements 179, 181, 183, and 185) would be selectively responsive to motion in the physical X-direction, an alternative second circuit connection between the same first and second differential pairs would be selectively responsive to motion in the physical Z-direction.

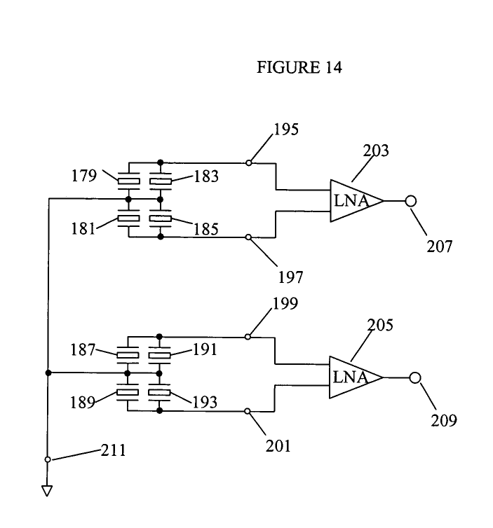

A further embodiment of the present invention is shown in the circuit diagram of FIG. 14 wherein the piezoelectric elements of the FIG. 13 device are electrically connected to form an open-loop dual-axis accelerometer. That is, the device in FIG. 14 is a sensor that simultaneously generates two separate electrical output signals corresponding to acceleration in two of the three orthogonal physical directions. In FIG. 14 (reference to the FIG. 13 arrangement), piezoelectric elements 179 and 183 are connected together at circuit node 195 while piezoelectric elements 181 and 185 are connected at circuit node 197 to create a differential output signal. As described in FIG. 7, during a lateral acceleration along the physical X-direction, elements 179 and 183 will generate an electrical output signal of a first polarity, while elements 181 and 185 will generate an electrical output signal of a second polarity. The resulting combined differential electrical output signal between circuit nodes 195 and 197 is highly selective to acceleration in the physical X-direction by virtue of the symmetry. Similarly, piezoelectric elements 187 and 191 are connected together at circuit node 199 while elements 189 and 193 are connected together at circuit node 201 to create a differential output signal. As described in FIG. 7, during a lateral acceleration along the physical Y-direction, elements 187 and 191 will generate an electrical output signal of a first polarity, while elements 189 and 193 will generate an electrical output signal of a second polarity. The resulting combined differential electrical output signal between circuit nodes 199 and 201 is highly selective to acceleration in the physical Y-direction by virtue of the symmetry. Other elements of FIG. 14 include external low-noise amplifiers (LNAs) that measure the difference of each combined differential electrical output signal and generate a secondary output in proportion to the acceleration along the X-axis and Y-axis physical directions. In FIG. 14, a first LNA 203 combines the differential electrical signal between circuit nodes 195 and 197 to create a first electrical output signal at circuit node 207 in proportion to acceleration along the X-axis. Also in FIG. 14, a second LNA 205 combines the differential electrical signal between circuit nodes 199 and 201 to create a second electrical output signal at circuit node 209 in proportion to acceleration along the Y-axis. Although not shown in the figures, had the elements 179 and 185 been connected together at circuit node 195 while the elements 181 and 183 were connected together at circuit node 197, they would have generated a differential electrical output signal proportional to acceleration along the physical Z-axis direction instead of the X-direction. As with most embodiments of the present invention, the piezoelectric element arrangement and the electrical connections between them both determine the physical direction of selective response.

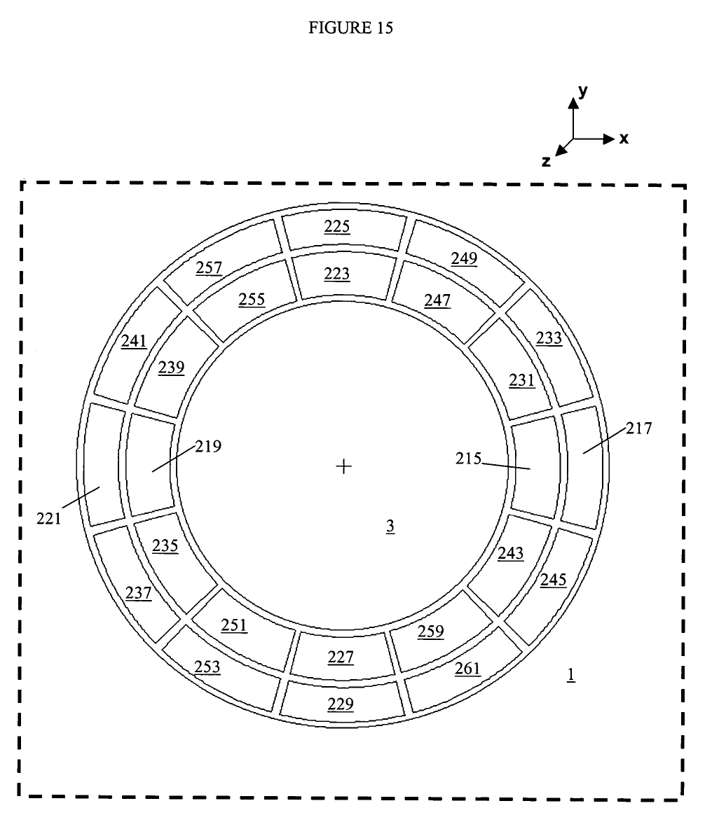

A simplified top view of another embodiment of the present invention is shown in FIG. 15. FIG. 15 illustrates the piezoelectric element configuration for a motion transducer consistent with the cross sectional views of FIG. 1 and FIG. 2. This device is comprised of 24 piezoelectric elements arranged as 12 differential element pairs. Piezoelectric element pairs include a first pair comprised of elements 215 and 217, a second pair comprised of elements 219 and 221, a third pair comprised of elements 223 and 225, a fourth pair comprised of elements 227 and 229, a fifth pair comprised of elements 231 and 233, a sixth pair comprised of elements 235 and 237, a seventh pair comprised of elements 247 and 249, an eighth pair comprised of elements 251 and 253, a ninth pair comprised of elements 239 and 241, a tenth pair comprised of elements 243 and 245, an eleventh pair comprised of elements 255 and 257, and a twelfth pair comprised of elements 259 and 261. The first element pair (elements 215 and 217) is mirror-image symmetric about the Y-axis with the second element pair (elements 219 and 221) and when properly connected electrically, will be responsive to physical motion in the X-direction. Similarly, the third element pair (elements 223 and 225) is mirror-image symmetric about the X-axis with the fourth element pair (elements 227 and 229) and when properly connected electrically, will be responsive to physical motion in the Y-direction. The fifth element pair (elements 231 and 233) is 180-degree rotationally symmetric with the sixth element pair (elements 235 and 237) and with a first electrical connection, will be responsive to physical motion in the Z-direction. Alternative electrical connections of the fifth and sixth element pairs will make them responsive to physical motion in the X-direction or Y-direction. The seventh element pair (elements 247 and 249) is 180-degree rotationally symmetric with the eighth element pair (elements 251 and 253) and with a first electrical connection, will be responsive to physical motion in the Z-direction. Alternative electrical connections of the seventh and eighth element pairs will make them responsive to physical motion in the X-direction or Y-direction. The ninth element pair (elements 239 and 241) is 180-degree rotationally symmetric with the tenth element pair (elements 243 and 245) and with a first electrical connection, will be responsive to physical motion in the Z-direction. Alternative electrical connections of the ninth and tenth element pairs will make them responsive to physical motion in the X-direction or Y-direction. Lastly, the eleventh element pair (elements 255 and 257) is 180-degree rotationally symmetric with the twelfth element pair (elements 259 and 261) and with a first electrical connection, will be responsive to physical motion in the Z-direction. Alternative electrical connections of the eleventh and twelfth element pairs will make them responsive to physical motion in the X-direction or Y-direction. The various fifth through twelfth element pairs also have mirror-image symmetry about both the X-axis and Y-axis. Depending on the electrical connection of the fifth through twelfth element pairs, they can be selectively responsive to the X-, Y-, or Z-axis physical directions. As will become apparent below, the electrical connection of the elements determines the physical axis to which an element pair will respond. For instance, the first and second element pairs would be responsive to motion in the Z-direction in an alternative electrical connection arrangement.

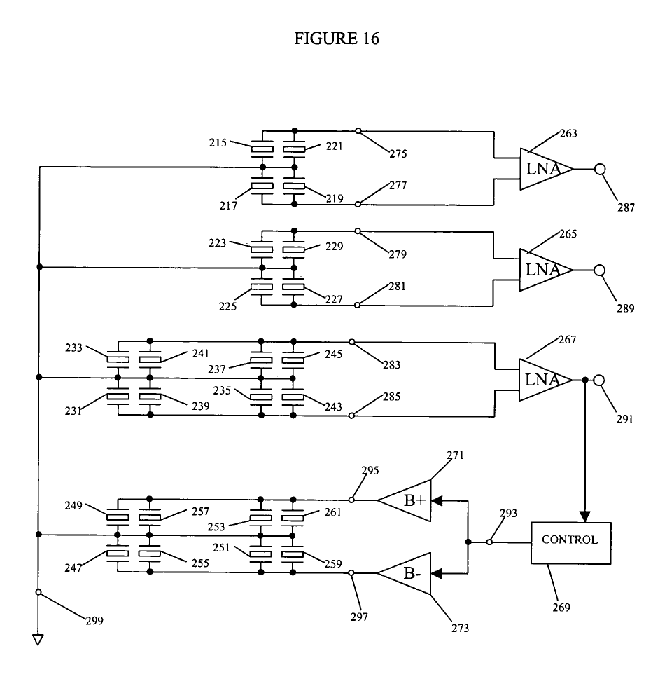

Another embodiment of the present invention is shown in the circuit diagram of FIG. 16 wherein the piezoelectric elements of the FIG. 15 device are electrically connected to form a closed-loop dual-axis rotational rate sensor. That is, the device in FIG. 16 is a sensor that simultaneously generates two electrical output signals proportional to the rate of rotation around the two axes parallel to the physical X- and Y-directions. In FIG. 16 (reference to the FIG. 15 arrangement), piezoelectric elements 249, 257, 253, and 261 are connected together at circuit node 295 while elements 247, 255, 251, and 259 are connected together at circuit node 297 to create a differential actuator that selectively generates motion in the physical Z-direction when an electrical signal is applied between circuit nodes 295 and 297. The piezoelectric elements 233, 241, 237, and 245 are connected together at circuit node 283 while elements 231, 239, 235, and 243 are connected together at circuit node 285 to create a differential output signal proportional to motion in the physical Z-direction. As described in FIG. 6, during a vertical acceleration along the physical Z-direction, elements 233, 241, 237, and 245 will generate an electrical output signal of a first polarity, while elements 231, 239, 235, and 243 will generate an electrical output signal of a second polarity. The resulting combined differential electrical output signal between circuit nodes 283 and 285 is highly selective to acceleration in the physical Z-direction by virtue of the symmetry. Similarly, piezoelectric elements 223 and 229 are connected together at circuit node 279 while elements 225 and 227 are connected together at circuit node 281 to create a differential output signal. As described in FIG. 7, during a lateral acceleration along the physical Y-direction, elements 223 and 229 will generate an electrical output signal of a first polarity, while elements 225 and 227 will generate an electrical output signal of a second polarity. The resulting combined differential electrical output signal between circuit nodes 279 and 281 is highly selective to acceleration in the physical Y-direction by virtue of the symmetry. Lastly, piezoelectric elements 215 and 221 are connected together at circuit node 275 while elements 217 and 219 are connected together at circuit node 277 to create a differential output signal. As described in FIG. 7, during a lateral acceleration along the physical X-direction, elements 215 and 221 will generate an electrical output signal of a first polarity, while elements 217 and 219 will generate an electrical output signal of a second polarity. The resulting combined differential electrical output signal between circuit nodes 275 and 277 is highly selective to acceleration in the physical X-direction by virtue of the symmetry. Other elements of FIG. 16 include external low-noise amplifiers (LNA) that measure the difference of each combined differential electrical output signal and generate a secondary output in proportion to the acceleration along each orthogonal physical direction. A first LNA 263 generates an output signal at circuit node 287 in proportion to the acceleration along the physical X-direction. A second LNA 265 generates an output signal at circuit node 289 in proportion to the acceleration along the physical Y-direction. A third LNA 267 generates an output signal at circuit node 291 in proportion to the acceleration along the physical Z-direction. Additional external electronic elements of FIG. 16 include CONTROL electronics 269 which process the output signal at circuit node 291 which is proportional to Z-axis acceleration and generates a drive signal at circuit node 293. Actuator drivers 271 and 273 generate the differential actuation signals at circuit nodes 295 and 297. The external electronics in conjunction with the motion transducer form a feedback loop that create a stable mechanical vibration along the Z-axis consistent with the motion depicted in FIG. 6. According to the Coriolis effect, if the device is then subjected to rotation about an axis parallel to the physical X-direction, a proportional acceleration will occur in the Y-axis direction and be detected at the output of the second LNA 265, i.e. at circuit node 289. The electrical output signal at circuit node 289 is thereby proportional to the rate of rotation about the X-axis. Also according to the Coriolis effect, if the device is subjected to rotation about an axis parallel to the physical Y-direction, a proportional acceleration will occur in the X-axis direction and be detected at the output of the first LNA 263, i.e. at circuit node 287. The electrical output signal at circuit node 287 is thereby proportional to the rate of rotation about the Y-axis.

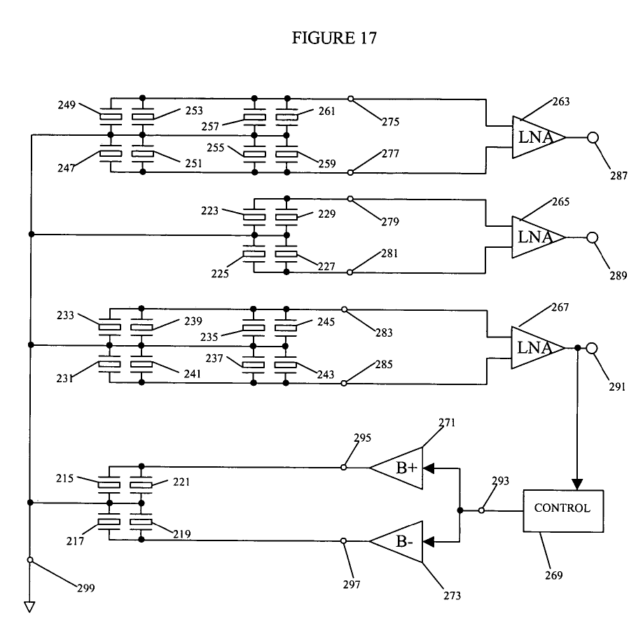

Still another embodiment of the present invention is shown in the circuit diagram of FIG. 17 wherein the piezoelectric elements of the FIG. 15 device are electrically connected to form another closed-loop dual-axis rotational rate sensor. That is, the device in FIG. 17 is a sensor that simultaneously generates two electrical output signals proportional to the rate of rotation around the two axes parallel to the physical Z- and Y-directions. In FIG. 17 (reference to the FIG. 15 arrangement), piezoelectric elements 215 and 221 are connected together at circuit node 295 while elements 217 and 219 are connected together at circuit node 297 to create a differential actuator that selectively generates motion in the physical X-direction when an electrical signal is applied between circuit nodes 295 and 297. The piezoelectric elements 233, 239, 235, and 245 are connected together at circuit node 283 while elements 231, 241, 237, and 243 are connected together at circuit node 285 to create a differential output signal proportional to motion in the physical X-direction. As described in FIG. 7, during a lateral acceleration along the physical X-direction, elements 233, 239, 235, and 245 will generate an electrical output signal of a first polarity, while elements 231, 241, 237, and 243 will generate an electrical output signal of a second polarity. The resulting combined differential electrical output signal between circuit nodes 283 and 285 is highly selective to acceleration in the physical X-direction by virtue of the symmetry. Similarly, piezoelectric elements 223 and 229 are connected together at circuit node 279 while elements 225 and 227 are connected together at circuit node 281 to create a differential output signal. As described in FIG. 7, during a lateral acceleration along the physical Y-direction, elements 223 and 229 will generate an electrical output signal of a first polarity, while elements 225 and 227 will generate an electrical output signal of a second polarity. The resulting combined differential electrical output signal between circuit nodes 279 and 281 is highly selective to acceleration in the physical Y-direction by virtue of the symmetry. Lastly, piezoelectric elements 249, 253, 257, and 261 are connected together at circuit node 275 while elements 247, 251, 255, and 259 are connected together at circuit node 277 to create a differential output signal. As described in FIG. 6, during a vertical acceleration along the physical Z-direction, elements 249, 253, 257, and 261 will generate an electrical output signal of a first polarity, while elements 247, 251, 255, and 259 will generate an electrical output signal of a second polarity. The resulting combined differential electrical output signal between circuit nodes 275 and 277 is highly selective to acceleration in the physical Z-direction by virtue of the symmetry. Other elements of FIG. 17 include external low-noise amplifiers (LNA) that measure the difference of each combined differential electrical output signal and generate a secondary output in proportion to the acceleration along each orthogonal physical direction. A first LNA 263 generates an output signal at circuit node 287 in proportion to the acceleration along the physical Z-direction. A second LNA 265 generates an output signal at circuit node 289 in proportion to the acceleration along the physical Y-direction. A third LNA 267 generates an output signal at circuit node 291 in proportion to the acceleration along the physical X-direction. Additional external electronic elements of FIG. 17 include CONTROL electronics 269 which process the output signal at circuit node 291 which is proportional to X-axis acceleration and generates a drive signal at circuit node 293. Actuator drivers 271 and 273 generate the differential actuation signals at circuit nodes 295 and 297. The external electronics in conjunction with the motion transducer form a feedback loop that create a stable mechanical vibration along the X-axis consistent with the motion depicted in FIG. 7. According to the Coriolis effect, if the device is then subjected to rotation about an axis parallel to the physical Z-direction, a proportional acceleration will occur in the Y-axis direction and be detected at the output of the second LNA 265, i.e. at circuit node 289. The electrical output signal at circuit node 289 is thereby proportional to the rate of rotation about the Z-axis. Also according to the Coriolis effect, if the device is subjected to rotation about an axis parallel to the physical Y-direction, a proportional acceleration will occur in the Z-axis direction and be detected at the output of the first LNA 263, i.e. at circuit node 287. The electrical output signal at circuit node 287 is thereby proportional to the rate of rotation about the Y-axis.

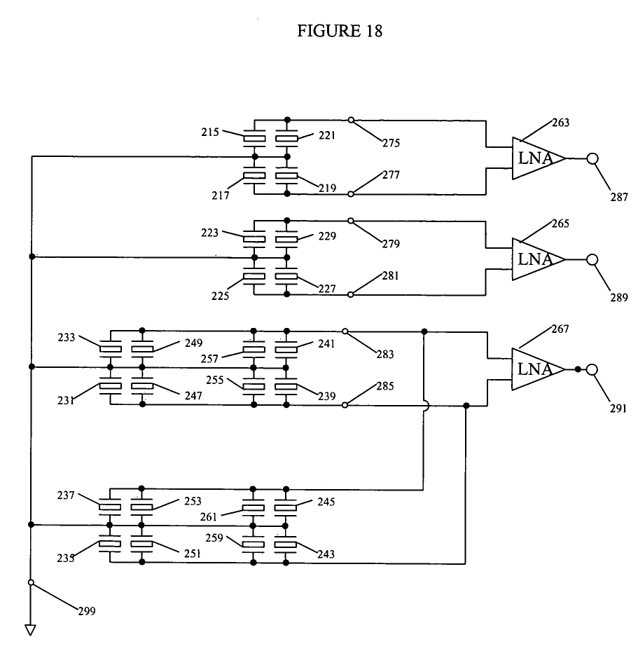

Still another embodiment of the present invention is shown in the circuit diagram of FIG. 18 wherein the piezoelectric elements of the FIG. 15 device are electrically connected to form an open-loop triaxial accelerometer. That is, the device in FIG. 18 is a sensor that simultaneously generates three separate electrical output signals corresponding to acceleration in each of the three orthogonal physical directions. In FIG. 18 (reference to the FIG. 15 arrangement), piezoelectric elements 215 and 221 are connected together at circuit node 275 while elements 217 and 219 are connected together at circuit node 277 to create a differential output signal. As described in FIG. 7, during a lateral acceleration along the physical X-direction, elements 215 and 221 will generate an electrical output signal of a first polarity, while elements 217 and 219 will generate an electrical output signal of a second polarity. The resulting combined differential electrical output signal between circuit nodes 275 and 277 is highly selective to acceleration in the physical X-direction by virtue of the symmetry. Similarly, piezoelectric elements 223 and 229 are connected together at circuit node 279 while elements 225 and 227 are connected together at circuit node 281 to create a differential output signal. As described in FIG. 7, during a lateral acceleration along the physical Y-direction, elements 223 and 229 will generate an electrical output signal of a first polarity, while elements 225 and 227 will generate an electrical output signal of a second polarity. The resulting combined differential electrical output signal between circuit nodes 279 and 281 is highly selective to acceleration in the physical Y-direction by virtue of the symmetry. Lastly, piezoelectric elements 233, 249, 257, 241, 237, 253, 261, and 245 are connected together at circuit node 283 while elements 231, 247, 255, 239, 235, 251, 259, and 243 are connected together at circuit node 285 to create a differential output signal. As described in FIG. 6, during a vertical acceleration along the physical Z-direction, elements 233, 249, 257, 241, 237, 253, 261, and 245 will generate an electrical output signal of a first polarity, while elements 231, 247, 255, 239, 235, 251, 259, and 243 will generate an electrical output signal of a second polarity. The resulting combined differential electrical output signal is highly selective to acceleration in the physical Z-direction by virtue of the symmetry. Other elements of FIG. 18 include external low-noise amplifiers (LNA) that measure the difference of each combined differential electrical output signal and generate a secondary output in proportion to the acceleration along each orthogonal physical direction. A first LNA 263 generates an output signal at circuit node 287 in proportion to the acceleration along the physical X-direction. A second LNA 265 generates an output signal at circuit node 289 in proportion to the acceleration along the physical Y-direction. A third LNA 267 generates an output signal at circuit node 291 in proportion to the acceleration along the physical Z-direction.

The embodiments described in FIGS. 15, 16, 17, and 18 illustrate the present invention whereby a variety of motion devices can be configured by modifying the electrical connections between piezoelectric elements and external electronics. There are a wide variety of electrical connections and external electronics that may be reconfigured to achieve a particular function. The embodiments presented here are illustrative in nature and not intended to limit the scope or spirit of the present invention.

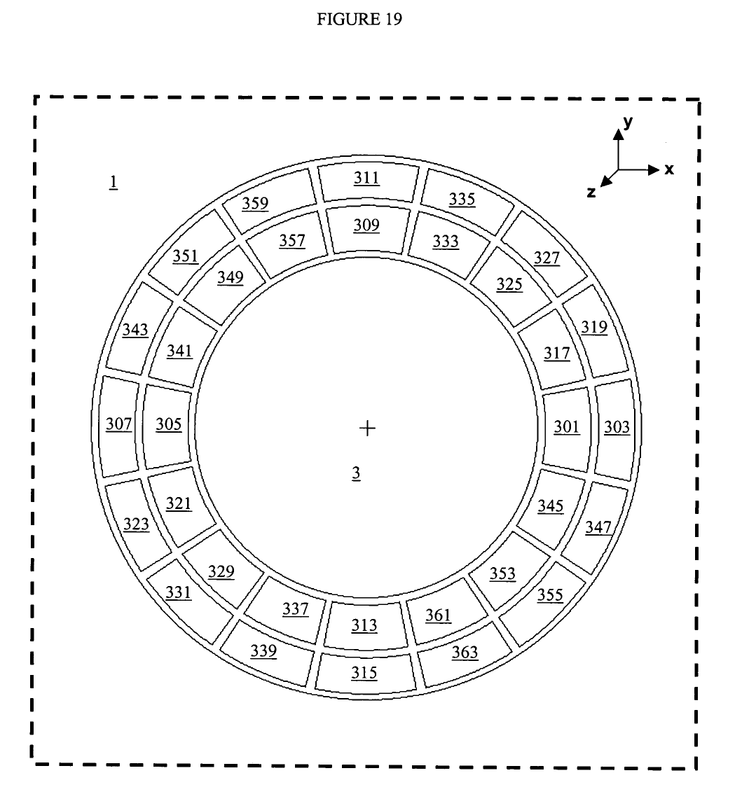

A simplified top view of still another embodiment of the present invention is shown in FIG. 19. FIG. 19 illustrates the piezoelectric element configuration for a motion transducer consistent with the cross sectional views of FIG. 1 and FIG. 2. device is comprised of 32 piezoelectric elements arranged as 16 differential element pairs. Piezoelectric element pairs include a first pair comprised of elements 301 and 303, a second pair comprised of elements 305 and 307, a third pair comprised of elements 309 and 311, a fourth pair comprised of elements 313 and 315, a fifth pair comprised of elements 317 and 319, a sixth pair comprised of elements 321 and 323, a seventh pair comprised of elements 325 and 327, an eighth pair comprised of elements 329 and 331, a ninth pair comprised of elements 333 and 335, a tenth pair comprised of elements 337 and 339, an eleventh pair comprised of elements 341 and 343, a twelfth pair comprised of elements 345 and 347, a thirteenth pair comprised of elements 349 and 351, a fourteenth pair comprised of elements 353 and 355, a fifteenth pair comprised of elements 357 and 359, and a sixteenth pair comprised of 361 and 363. The symmetry principles of this piezoelectric element design and specificity with each of the physical X-, Y-, and Z-directions are addressed in consistent with the embodiments in FIGS. 4, 5, 11, 13, and 15. The element arrangement of FIG. 19 is capable of producing a wide range of multi-directional sensor and actuator functions depending on the interconnection of the elements and the external electronics. Moreover, a wide variety of piezoelectric element configurations are possible within the scope of the present invention.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention.

What is claimed is:

1. A solid-state sensor device for sensing acceleration along a specific direction, comprising:
a substrate containing a cavity;
a mass being disposed in the cavity;
a thin film toroidal support membrane disposed on the mass; and
a plurality of thin film piezoelectric elements disposed on the support membrane and arranged to generate an electrical signal upon accelerating the sensor device along the specific direction.

2. The solid-state sensor device of claim 1 wherein the thin film piezoelectric elements are arranged in differential pairs.

3. The solid-state sensor device of claim 2 wherein area of each thin film piezoelectric element in each differential pair is the same.

4. The solid-state sensor device of claim 3 wherein a differential pair of thin film piezoelectric elements has an identical mirror image pair with respect to a plane through a center of the mass.

5. The solid-state sensor device of claim 3 wherein a differential pair of thin film piezoelectric elements has an identical mirror image pair with respect to a 180 degree rotation around a center of the mass.

6. The solid-state sensor device of claim 3 wherein the differential pairs of thin film piezoelectric elements are identical through any combination of 180 degree rotations and mirror images through a set of orthogonal planar axes.

7. A solid-state rotational rate sensor device for sensing rotational rate around a first direction upon actuating the device along a second direction, comprising:
a substrate containing a cavity;
a mass being disposed in the cavity;
a thin film toroidal support membrane disposed on the mass;
a first set of thin-film piezoelectric elements disposed on the support membrane and arranged to generate an electrical signal upon accelerating the sensor device along the first direction; and
a second set of thin-film piezoelectric elements disposed on the support membrane and arranged to generate a motion along the second direction.

8. The solid-state sensor device of claim 7 wherein the first and/or second thin film piezoelectric elements are arranged in differential pairs.

9. The solid-state sensor device of claim 8 wherein area of each thin film piezoelectric element in each differential pair is the same.

10. The solid-state sensor device of claim 9 wherein a differential pair of thin film piezoelectric elements has an identical mirror image pair with respect to a plane through a center of the mass.

11. The solid-state sensor device of claim 9 wherein a differential pair of thin film piezoelectric elements has an identical mirror image pair with respect to a 180 degree rotation around a center of the mass.

12. The solid-state sensor device of claim 9 wherein the differential pairs of thin film piezoelectric elements are identical through any combination of 180 degree rotations and mirror images through a set of orthogonal planar axes.

13. A solid-state actuator device for generating motion along a specific direction, comprising:
a substrate containing a cavity;
a mass being disposed in the cavity;
a thin film toroidal support membrane disposed on the mass; and
a plurality of thin film piezoelectric elements disposed on the toroidal support membrane and arranged to generate motion along the specific direction upon applying an electrical signal.

14. The solid-state actuator device of claim 13 wherein the thin film piezoelectric elements are arranged in differential pairs.

15. The solid-state actuator device of claim 14 wherein area of each thin film piezoelectric element in each differential pair is the same.

16. The solid-state actuator device of claim 15 wherein a differential pair of thin film piezoelectric elements has an identical mirror image pair with respect to a plane through a center of the mass.

17. The solid-state actuator device of claim 15 wherein a differential pair of thin film piezoelectric elements has an identical mirror image pair with respect to a 180 degree rotation around a center of the mass.

18. The solid-state actuator device of claim 15 wherein the differential pairs of thin film piezoelectric elements are identical through any combination of 180 degree rotations and mirror images through a set of orthogonal planar axes.
